(19) United States
(12) Patent Application Publication
(10) Pub. No.: US 2002/0069538 A1
(43) Pub. Date: Jun. 13, 2002

(54) Shears

(76) Inventor: Richard Frederick Tanton, Ashford (GB)

Correspondence Address: RICHARD F. TANTON, LODGE FARM, BOWL ROAD, CHARING, ASHFORD, KENT TN27 OHB, GB

(21) Appl. No.: 10/051,944

(22) Filed: Jan. 22, 2002

(30) Foreign Application Priority Data
Dec. 12, 2000 (GB) 0030320.6

(51) Int. Cl. B26B 13/26; B26B 13/22

(52) U.S. Cl. 30/246; 30/261; 30/257; 30/131

(57) ABSTRACT

The shear blades of a lawn edge trimming shears are angularly relatively displaceable about the pivotal coupling between the blades under the action of a spring restored motion conversion means operable to convert downwards translational motion imparted to the conversion means by the application of a downwards manual force applied at the single handle with which the shears is provided, into a torque acting to produce relative angular displacement, about their pivotal coupling, between the shear blades.

Three embodiments of the above principle are described, the motion conversion means of two of which are four-bar linkages, and the third of which is a three-bar linkage incorporating a pin and slot connection.

### BACKGROUND TO THE INVENTION

1. Field of the Invention

This invention relates to lawn edge trimming shears, the shear blades of which are pivotal about a common axis that, in use of the shears, lies substantially in an horizontal plane. Lawn edge trimming shears as aforesaid are hereinafter referred to as “shears of the kind alluded to”.

Lawn edge trimming shears of the kind alluded to customarily have the shear blades thereof at the ends of long handles, the blades being pivotally coupled together at a location near to the cranked portions between the blades and the handles, grass being sheared by scissor action at the blades under opening and closing action at the handles.

It is considered that such shears are cumbersome and uncomfortable in their use, especially by the young and the physically less able, and it is an object of this invention to provide a shears of the kind alluded to but which is not subject to the aforesaid criticisms, being easy to use whether or not by the physically able.

The present invention is concerned with shears of the kind alluded to in that the shear blades of the shears are pivotal about a common horizontal axis. However, in distinction from lawn-edge trimming shears in the conventional form referred to above, shears in accordance with the present invention are operable by downward thrust applied at the free top end of a shaft, longitudinal displacement of the shaft being converted by motion conversion means to relative rotary displacement of the shear blades about their common horizontal axis, and the downward thrust applied at the shaft being reacted by ground contact between the lawn edge and reaction means connected to the shear blades at the pivotal joint defining said horizontal axis.

2. Description of Prior Art

U.S. Pat. No. 4.021,998 discloses a shears of the kind alluded to, being a shears which is operable by downward manual force applied at one of two coaxially related manual members and manually reacted at the other against a spring bias between the coaxial members. The action of the shears is transmitted not only to the shear blades but also to a wheel, causing the latter to rotate and, in rotating to propel the shears along the lawn edge. Apart from the relative mechanical complexity, and cost penalty involved in such an arrangement, the lower one of the shear blades is held stationary, the upper blade only pivoting about the common horizontal axis. It is a demonstrable truth, that it is upwards pivotal motion of the lower one of the shear blades that is the principal contributory factor in the efficient operation of the shears in cutting the lawn edge. It is a characteristic of shears in accordance with the present invention, that whether or not the upper blade is pivotal, the lower blade invariably is pivotal. Moreover, in distinction from the arrangement of U.S. Pat. No. 4,021,998, which requires the use of both hands for its operation, the shears of the 25 present invention may truly be operated single-handedly, and the lesser complexity foretells a lesser maintenance or longevity problem for the shears.

### BRIEF SUMMARY OF THE INVENTION

According to the invention, shears of the kind alluded to are as specified in the claiming clauses, or any of them, accompanying this Application and, accordingly, the content of said claiming clauses and the inter-relationships therebetween are to be regarded, notionally, as being here set forth, also.

### BRIEF DESCRIPTION OF DRAWINGS

Three embodiments of a shears of the kind alluded to, being shears in accordance with the invention, are hereinafter described with reference to the accompanying drawings in which:

FIG. 1 shows, in front elevation, a lawn-edge trimming shears in accordance with a first embodiment of the invention, the shears being shown with its several parts in a first configuration, the shear blades being then in the open position;

FIG. 2 shows, in side elevation, the shears depicted in FIG. 1;

FIG. 3 shows, in front elevation, the shears of FIGS. 1 and 2 but with the several part in a second configuration, the shear blades being now in the closed position;

FIG. 4 shows, in front elevation, a lawn edge trimming shears in accordance with a second embodiment of the invention, the shears being shown in the configuration in which the shear blades thereof are in the open position; and,

FIG. 5 shows, in front elevation, in a closed position, a lawn-edge trimming shears in accordance with a third embodiment of the invention.

### DESCRIPTION OF PREFERRED EMBODIMENTS OF THE INVENTION

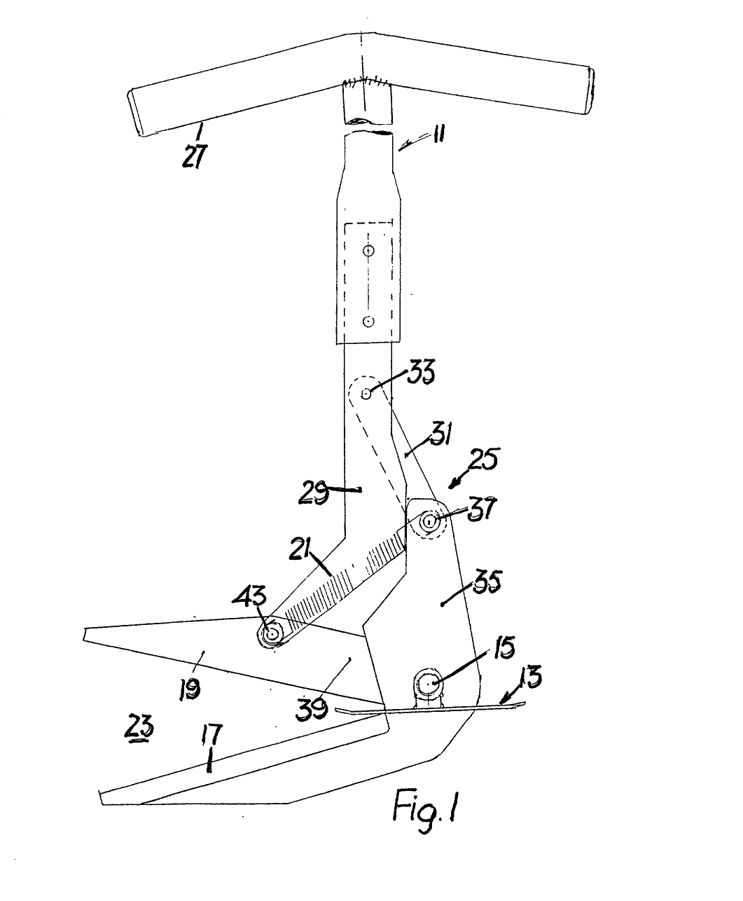

A lawn-edge trimming shears of the kind alluded to comprises, in each of the three illustrated embodiments, a manual shears-operating part 11, load reaction means 13 supported at the pivotal coupling 15 between the lower and upper shear blades 17, 19, respectively, spring means 21 serving to bias said shear blades towards an angularly displaced, open, position, as represented in FIG. 1, at which said shear blades present a mouth 23 for the reception of grass to be trimmed; and, means 25 serving to couple said manual shears-operating part to at least the lower one 17 of the shear blades 17, 19. The load reaction means 13 is, in use, of the shears, to be brought to ground contact.

The coupling means 25 is such as, in use, said load reaction means 13 having been brought to contact with the ground, by generally rectilinear displacement of the shears-operating part 11 under downwards force applied thereto at a handle cross-member 27, to convert such rectilinear displacement of the shears-operating part 11 to angular relative displacement between the shear blades 17, 19, being an angular displacement in the sense to produce shearing closure action (FIG. 1} between the shear blades. Upon loss of contact between the load reaction means 13 and the ground, the shear blades 17, 19, are able to recover said angularly displaced, open, position under the restoring action of the spring means 21.

In each of the embodiments, the coupling means 25 relies for its performance upon relative movement between several mechanically-engaging parts by which said coupling means is constituted.

In the embodiment of FIGS. 1 to 3, the coupling means 25 comprises a four-bar linkage. The linkage comprises, rigid with the shears-operating part 11, a linkage first element 29, a linkage second element 31 connected to the linkage first element 29 at a linkage first pivotal coupling 33, a linkage third element 35 rigid with the lower shear blade 17 and having a linkage second pivotal coupling 37 with said linkage second element 31, and a linkage fourth element 39 which extends between a linkage third pivotal coupling, constituted by the pivotal coupling 15 between the said shear blades 17, 19, and a linkage fourth pivotal coupling 43 between the linkage fourth and first elements 39, 29.

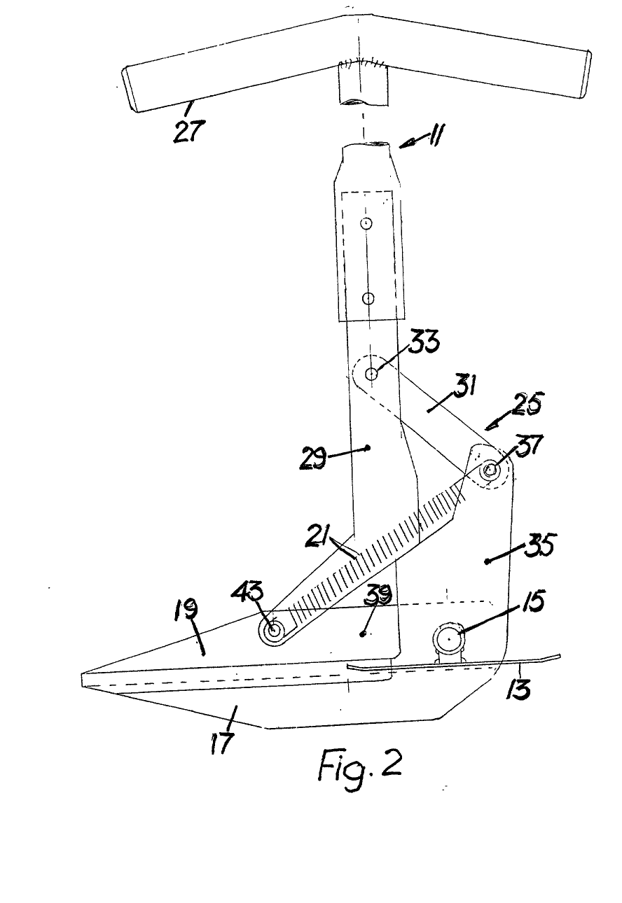

The pivot axes of the four pivotal couplings 33, 37, 15, 43, are parallel to one another, and the spacing between the pivot axes of these pivotal couplings are such as, in use, under downwards force applied to the handle cross member 27 of the shears-operating part 11, and reacted at the reaction means 13, movement of the shears-operating part 11 gives rise, at the several pivotal couplings, to angular movements between the linkage elements 29, 31, 35, 39, of magnitudes such as to produce in the shear blades 17, 19, angular displacements, of opposite sense, about their pivotal coupling 15, the shear blades 17, 19, moving from the angularly displaced relationship of FIG. 1 to the shear-action closure position of FIG. 2.

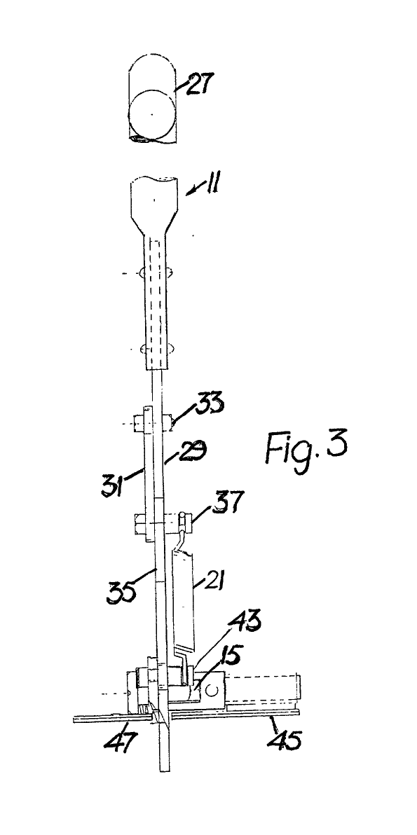

The reaction means comprises, as shown, platform means comprising (FIG. 3) first and second platform portions 45, 47, respectively, the platform portions being supported from the linkage third pivotal coupling, that is to say, the pivotal coupling 15 between the shear blades 17, 19, the one 45 to one side of the blades, the other to the other side. The provision of platform portions 45, 47, one at each side of the blades renders the shears easily usable regardless of whether the lawn edge is being tracked, in use of the shears, in one direction or the other. The platform portions 45, 47, should have the largest practicable surface area in order to keep pressures developed between the platform portions and the ground to as low a value as possible.

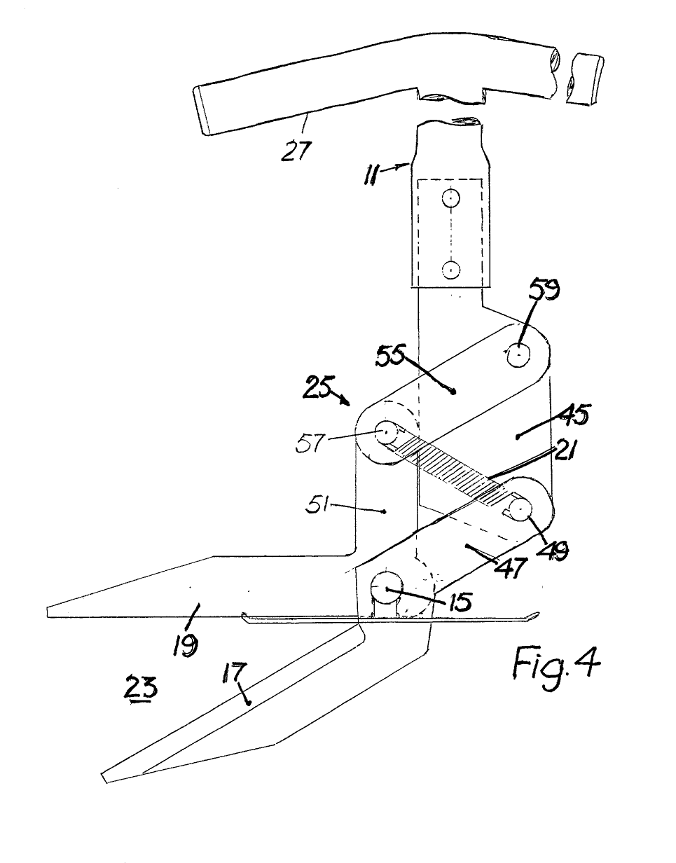

The spring means 21 comprises a conventional helical spring connected at one end to the linkage second pivotal coupling 37 and at the other to the linkage fourth coupling 43.

Whereas, in the first embodiment, the shear blades 17, 19, are both displaceable angularly, though in opposite senses, about the shear blade pivotal coupling, in the embodiment of FIG. 4, it is the lower shear blade 17 alone that is so displaceable.

Although, in the embodiments of FIGS. 1 to 3, the coupling means 25 for converting rectilinear displacement of the shears-operating part 11 into relative angular displacement of the shear blades 17, 19, about their pivotal coupling, is constituted as a four-bar linkage, in the arrangement of FIG. 4, that linkage is implemented as a true parallel motion device.

More specifically, the coupling means 25 of the arrangement of FIG. 4, comprises a four-bar linkage having: a linkage first element 45 rigid with the shears-operating part 11; a linkage second element 47 rigid with the lower one of said shear blades 17 and having a linkage first pivotal coupling 49 with said linkage first element 45; a linkage third element 51 rigid with the upper shear blade 19 and having a linkage second pivotal coupling, the shear blade pivotal coupling 15 that is, with the linkage second element 47; and a linkage fourth element 55, which extends between a linkage third pivotal coupling 57 with the third pivotal coupling and a linkage fourth pivotal coupling 59, between the linkage fourth and first elements 55, 45, respectively.

The pivot axes of the four said pivotal couplings are, as before, parallel to one another; and the spacings between the axes of the several linkage pivotal couplings are such that, opposite linkage elements 45, 51; 47; 55, being of equal length, the linkage constitutes a parallel motion linkage, the upper shear blade 19 being held by the linkage at a position angularly fixed, in the example, perpendicular to the longitudinal direction of the manual shears-operating part 11. Relative angular displacement between said shear blades 17, 19, is by movement solely of said lower shear blade 17 with respect to the upper shear blade 19.

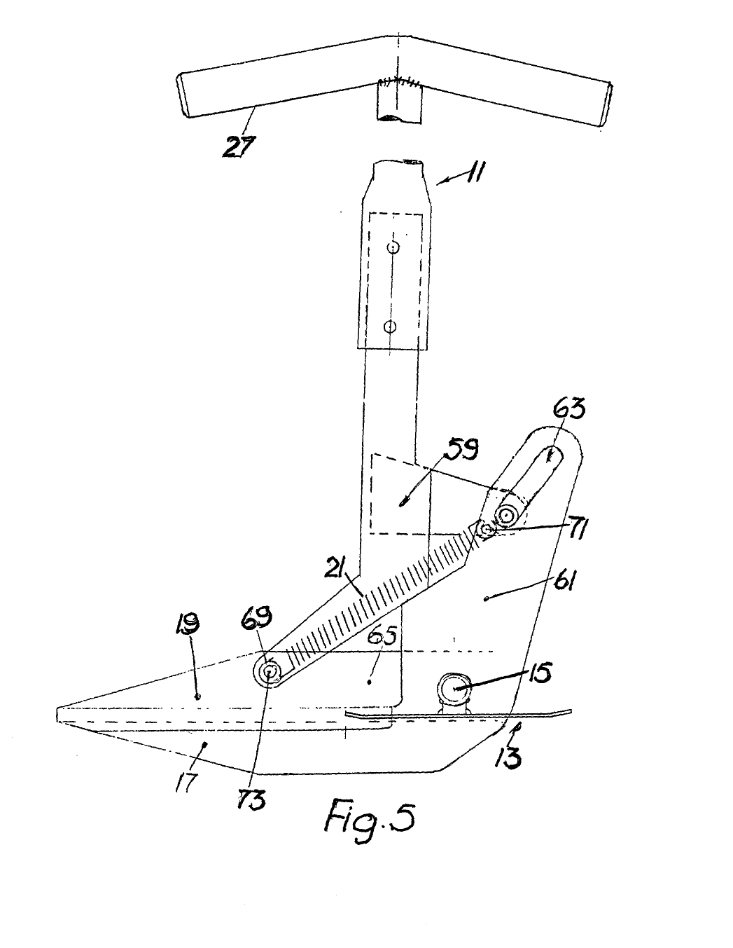

In the two above described embodiments, the control means 25 is constituted by a four-bar linkage. In the arrangement of FIG. 5, a three-bar linkage is used.

The three bar linkage of FIG. 5 comprises linkage first, second and third link elements 59, 61, and 63, respectively. The first link element 59 is rigid with the shears-operating part 11. The second link element 61 is rigid with the lower shear blade 17 and has a pin and slot connection 63 with the first link element 59. The third link element 65 has a linkage first pivotal coupling, being the pivotal coupling 15 between the upper and lower said shear blades 17, 19, and has, also, a linkage second pivotal coupling 69 with the first link element 59. The spring means 21 of the shears is an helical spring connected between a first anchorage 71 integral with the link element 61 and a second anchorage 73 movable with the upper shear blade 19 and, hence, with the third link element 65.

It will have been noted already that, in each of the described embodiments of the shears, certain of the linkage elements of the shears are formed integral with certain other parts of the shears.

So, in the first described embodiment, the first link element 29 is an integral portion of the shears-operating part 11, the third link element 35 is constituted as an integral portion of the lower shear blade 19, and the fourth link element 39 is constituted as an integral portion of the upper shear blade 17.

In the second described embodiment, the first link element 45 forms an integral portion of the shears-operating part 11, and the third link element 51 forms an integral portion of the upper shear blade 17.

In the third described embodiment, the first link element 59 forms an integral portion of the shears-operating part 11, and the second link element 61 forms part of said lower shears blade 17.

1. A shears of the kind alluded to, and which comprises:
a manual shears-operating part, being a shaft;
load reaction means supported at a pivotal coupling between the shear blades, being load reaction means to be brought, in use of the shears, to contact with the lawn surface at the lawn edge;
spring means serving to bias said shear blades towards an angularly mutually displaced, open, position at which the blades present a mouth for the reception of grass to be trimmed; and,
coupling said shear blades to said shaft, motion conversion means such and so operative as, the load reaction means having been brought to contact with the lawn surface at an edge of a lawn, to convert longitudinal displacement of the shaft under a load acting thereon in its longitudinal direction, into angular displacement about the shear blade pivotal axis at the lower one, at least, of the two shear blades, being an angular displacement of said at least the lower shear blade, in the sense to produce, a shearing closure action between the shear blades, and being operable, also, upon removal of said load, and, hence, of the reaction thereto at the load reaction means, to return said shear blades to the angularly mutually displaced, open, position under the restorative force exerted by the spring means.

2. A shears as claimed in claim 1 in which: said coupling means comprises a four-bar linkage having:
a linkage first element rigid with said shaft;
a linkage second element connected to said linkage first element at a linkage first pivotal coupling;
a linkage third element rigid with the lower one of said shear blades and having a linkage second pivotal coupling with said linkage second element; and,
a linkage fourth element which extends between a linkage third pivotal coupling, being the pivotal coupling between the upper and lower said shear blades and a linkage fourth pivotal coupling between said linkage fourth and first elements, being a pivotal coupling distinct from said linkage first pivotal coupling, and in which:
the pivot axes of the four said couplings are parallel to one another, and the spacing between the pivot axes of the several said linkage pivotal couplings are such as, in use, under a load applied longitudinally to said shaft, movement of the shaft gives rise, at the several said pivotal couplings, to angular movements between said linkage elements of magnitudes such as to produce in said shear blades angular displacements, of opposite sense, about their pivot axis.

3. A shears as claimed in claim 2 in which:
said linkage first element is constituted as an integral portion of said shaft, said linkage third element is constituted as an integral portion of said lower shear blade, and said fourth linkage element is constituted as an integral portion of said upper shear blade.

4. A shears as claimed in claim 3 in which: said spring means is connected between said linkage second and fourth pivotal couplings.

5. A shears as claimed in claim 1 in which said coupling means comprises a four-bar linkage having:
a linkage first element rigid with said shaft;
a linkage second element rigid with the lower one of said shear blades and having a linkage first pivotal coupling with said linkage first element;
a linkage third element rigid with the upper one of said shear blades and having a linkage second pivotal coupling with said linkage second element, being the pivotal coupling between the upper and lower said shear blades; and,
a linkage fourth element, which extends between a linkage third pivotal coupling and a linkage fourth pivotal coupling between said linkage fourth and first elements, being a pivotal coupling distinct from said linkage first pivotal coupling, and in which:
the pivot axes of the four said pivotal couplings are parallel to one another and the spacings between the axes of the several said linkage pivotal couplings are such that said linkage constitutes a parallel motion linkage, said upper shear blade being held thereby at a position angularly fixed with respect to said shaft, said relative angular displacement between said shear blades being under movement solely of said lower shear blade with respect to said upper shear blade.

6. A shears as claimed in claim 5 in which:
said linkage first element forms is constituted as an integral portion of said shaft; and;
said linkage third element is constituted as an integral portion of said upper shear blade.

7. A shears as claimed in claim 5 in which: said spring means is connected between said first and third linkage pivotal couplings.

8. A shears as claimed in claim 1 in which said motion conversion means comprises a three-bar linkage having:
a linkage first element rigid with said shaft;
a linkage second element rigid with said lower shear blade and having a pin and slot connection with said linkage first element;
a linkage third element having a linkage first pivotal coupling with said linkage second element, being the pivotal coupling between the upper and lower said shear blades, and having, also, a linkage second pivotal coupling with said linkage first element.

9. A shears as claimed in claim 8 in which said linkage first element forms part of said shaft, and the linkage second element forms part of said shears lower blade.

10. A shears as claimed in claim 9 in which: said spring means is connected between a first anchorage integral with said shaft and a second anchorage movable with said linkage third element.

11. A shears as claimed in claim 1 in which: said load reaction means comprises platform means mounted for pivotal movement about the axis of the pivotal coupling between said shear blades.

12. A shears as claimed in claim 11 in which said platform means comprises a first platform part to one side of said shearing blade pivotal coupling and a second platform part to the other.
